(19) United States
(12) Patent Application Publication
(10) Pub. No.: US 2017/0348842 A1
(43) Pub. Date: Dec. 7, 2017

(54) Machine Tool System

(71) Applicant: Robert Bosch GmbH, Stuttgart (DE)

(72) Inventors: Jens Blum, Filderstadt (DE); Heiko Roehm, Stuttgart (DE); Joerg Welke, Ettlingen-Schoellbronn (DE); Tobias Herr, Stuttgart (DE)

(21) Appl. No.: 15/535,359

(22) PCT Filed: Nov. 9, 2015
(86) PCT No.: PCT/EP2015/076025

§ 371 Date: Jun. 12, 2017

(30) Foreign Application Priority Data
Dec. 16, 2014 (DE) 10 2014 226 089.2

(51) Int. Cl. B25F 5/02; B24B 23/04

(52) U.S. Cl. CPC B25F 5/02; B24B 23/04

(57) ABSTRACT

A machine tool system includes at least one portable machine tool and at least one energy storage apparatus. The at least one portable machine tool includes at least one tool receptacle configured to be arrange a machining tool, and at least one receiving interface. The at least one energy storage apparatus is configured to be arranged on the at least one receiving interface of the at least one portable machine tool. At least in a state when the at least one energy storage apparatus is arranged on the at least one receiving interface, the at least one energy storage apparatus is arranged at least for the most part within a boundary region of the at least one tool receptacle.

### PRIOR ART

EP 2 607 016 A2 has already disclosed a machine tool system which comprises a portable machine tool which has a tool receptacle for arranging a machining tool, and a receiving interface. Furthermore, the machine tool system comprises an energy storage apparatus which can be arranged on the receiving interface of the portable machine tool, in particular can be arranged removably on the receiving interface of the portable machine tool. In a state, in which it is arranged on the receiving interface, the energy storage apparatus is arranged at least for the most part outside a boundary region of the tool receptacle.

### DISCLOSURE OF THE INVENTION

The invention proceeds from a machine tool system having at least one portable machine tool which comprises at least one tool receptacle for arranging a machining tool, and at least one receiving interface, and having at least one energy storage apparatus which can be arranged on the receiving interface of the portable machine tool, in particular can be arranged removably on the receiving interface of the portable machine tool.

It is proposed that, at least in a state, in which it is arranged on the receiving interface, the energy storage apparatus is arranged at least for the most part within a boundary region of the tool receptacle. Here, a “boundary region of the tool receptacle” is to be understood to mean, in particular, a region, in particular a spatial region, which is swept over during a (in particular, imaginary) parallel displacement of at least one tool receiving face of the tool receptacle. Here, the term “tool receiving face” is to define, in particular, an area, in particular a maximum area, of the tool receptacle, against which the machining tool bears in a state, in which it is arranged on the tool receptacle, and/or which runs, in particular, at least substantially perpendicularly with respect to a movement axis of the tool receptacle. Here, the expression “substantially perpendicularly” is to define, in particular, an orientation of a direction relative to a reference direction, the direction and the reference direction enclosing an angle of 90°, in particular as viewed in one plane, and the angle having a maximum deviation of, in particular, less than 8°, advantageously less than 5° and particularly advantageously less than 2°. Here, the expression “at least for the most part within the boundary region” is to define, in particular, an arrangement of an element, in particular of the energy storage apparatus, more than 80% in particular, preferably more than 85% and particularly preferably more than 95% of an overall volume of the element, in particular of the energy storage apparatus, being arranged within the boundary region. In a state, in which it is arranged on the receiving interface, the energy storage apparatus is very particularly preferably arranged completely within the boundary region, 100%, in particular, of the overall volume of the energy storage apparatus being arranged completely within the boundary region of the tool receptacle of the portable machine tool.

Here, a “portable machine tool” is to be understood to mean, in particular, a machine tool for machining workplaces, which machine tool can be transported by an operator without a transport machine. The portable machine tool has, in particular, a mass which is smaller than 40 kg, preferably smaller than 10 kg and. particularly preferably smaller than 5 kg. The machine tool can be configured as a portable angle grinder, as a hand-held circular saw, as a drill, as an impact drill, as a jigsaw, as a multi-functional machine, as a planing machine, as a router, or as another machine tool which appears appropriate to a person skilled in the art, in particular as an electrically operable portable machine tool. The portable machine tool is particularly preferably configured as a grinding machine, such as a rotary sander, an orbital sander or the like. The tool receptacle of the portable machine tool is preferably configured as a grinding disk or as an orbital plate, on which the machining tool, in particular a sanding sheet, can be arranged releasably. The portable machine tool preferably comprises at least one fixing unit which is provided to fasten the machining tool to the tool receptacle, in particular to fasten it releasably to the tool receptacle by means of a positively locking and/or non-positive connection. The fixing unit can be configured as a clamping unit, as a hook and loop fastener unit, as an adhesive unit, as a latching unit or as another fixing unit which appears appropriate to a person skilled in the art. “Provided” is to be understood to mean, in particular, specially designed and/or specially equipped. The fact that an element and/or a unit are/is provided for a defined function is to be understood to mean, in particular, that the element and/or the unit fulfill/fulfills and/or perform/performs this defined function in at least one use and/or operating state.

Here, a “receiving interface” is to be understood to mean, in particular, an interface which is provided at least for receiving an element and/or a unit, in particular the energy storage apparatus, in a positively locking and/or non-positive manner. At least one electric contact element of the portable machine tool is preferably arranged on the receiving interface, which electric contact element is provided for electric connection to a counter-contact element of the energy storage apparatus. The energy storage apparatus is preferably configured as an accumulator battery apparatus. The energy storage apparatus preferably comprises a multiplicity of rechargeable energy storage cells which are connected electrically to one another. The energy storage apparatus is particularly preferably configured as a removable accumulator battery pack.

An arrangement of the energy storage apparatus close to the center of the portable machine tool can advantageously be made possible by means of the configuration according to the invention. An optimized arrangement of the center of mass with regard to a movement axis of the tool receptacle can advantageously be achieved. Therefore, in particular in the case of a configuration of the portable machine tool as a grinding machine, a tendency to tilt of the portable machine tool when machining a workpiece can particularly advantageously be kept low. Therefore, precise machining of workpieces can advantageously be made possible. Furthermore, a large use spectrum of the portable machine tool can advantageously be realized as a consequence of a low projecting length of the energy storage apparatus beyond the boundary region, in particular beyond the tool receptacle. An advantageous corner accessibility can be achieved in as far as possible all orientation positions of the portable machine tool which are possible about the movement axis of the tool receptacle.

Furthermore, it is proposed that the tool receptacle has an axis which runs through a centroid of a tool receiving face of the tool receptacle, runs at least substantially perpendicularly with respect to the tool receiving face, and intersects the energy storage apparatus. The tool receiving face of the tool receptacle is preferably arranged on a side of the tool receptacle, which side faces away from a drive unit and/or a housing unit, of the portable machine tool. The tool receiving face can have any configuration which appears appropriate to a person skilled in the art. The tool receiving face is preferably of circular or polygonal, in particular rectangular or triangular, configuration. The axis which runs through a centroid of a tool receiving face of the tool receptacle preferably runs at least substantially parallel, in particular coaxially, with respect to a movement axis of the tool receptacle. Here, “substantially parallel” is to be understood to mean, in particular, an orientation of a direction relative to a reference direction, in particular in one plane, the direction having a deviation, in particular, of less than 8°, advantageously of less than 5° and particularly advantageously of less than 2° with respect to the reference direction. By means of the configuration according to the invention, an arrangement of the energy storage apparatus close to a center of the tool receptacle can particularly advantageously be realized. A low tendency to tilt of the portable machine tool can advantageously be achieved.

It is proposed, furthermore, that, at least in a state, in which it is arranged on the receiving interface, the energy storage apparatus is arranged between a handle region of a housing unit of the portable machine tool and the tool receptacle, as viewed along a movement axis of the tool receptacle. The movement axis of the tool receptacle is preferably configured as a rotational axis. The tool receptacle preferably rotates about the rotational axis, in particular eccentrically about the rotational axis, and/or the tool receptacle oscillates about the rotational axis, in particular eccentrically about the rotational axis. The portable machine tool can comprise a switchable gear mechanism unit which is provided to change a rotational speed and/or an oscillation speed of the tool receptacle. Here, a “handle region” is to be understood to mean, in particular, a region of the housing unit, on which an operator arranges at least one hand during correct operation of the portable machine tool. The handle region is preferably provided for the arrangement of a hand inner face. The handle region is preferably arranged on the housing unit on a side of the housing unit, which side faces away from the tool receptacle. A grip face, in particular a rubberized grip face, of the portable machine tool is preferably arranged in the handle region. The housing unit can have a shell design and/or a cup design. By means of the configuration according to the invention, a weight of the energy supply apparatus can advantageously be utilized to support an operator for pressing the portable machine tool onto a workpiece to be machined. A weight of the energy supply apparatus can advantageously be utilized as an additional centric pressing force.

In addition, it is proposed that, at least in a state, in which it is arranged on the receiving interface, the energy storage apparatus is covered at least partially on at least two sides by a housing unit of the portable machine tool. At least in a state, in which it is arranged on the receiving interface, the energy storage apparatus is preferably covered on at least two sides by a housing unit of the portable machine tool, as viewed along the movement axis of the tool receptacle. Here, “cover” is to be understood to mean, in particular, an arrangement of a plurality of elements relative to one another, an imaginary axis intersecting all elements, in particular at least in each case at one point of the respective element. The axis which runs through the centroid of the tool receiving face of the tool receptacle preferably intersects the housing unit and the energy storage apparatus. By means of the configuration according to the invention, a structurally simple arrangement of the energy apparatus in a near region of the movement axis of the tool receptacle can advantageously be made possible. An advantageous optimization of an arrangement of a center of mass of the portable machine tool can be achieved, which optimization makes high operator and/or machining comfort possible. Furthermore, reliable protection, in particular impact protection, of the energy storage apparatus can advantageously be made possible in a state, in which it is arranged on the receiving interface.

Furthermore, it is proposed that, at least in a state, in which it is arranged on the receiving interface, the energy storage apparatus is arranged at least partially between a handle region of a housing unit of the portable machine tool and a drive unit of the portable machine tool, as viewed along a movement axis of the tool receptacle. The drive unit is preferably configured as an electric motor unit. It is also conceivable, however, that the drive unit has another configuration which appears appropriate to a person skilled in the art, such as a pneumatic motor unit, an internal combustion engine unit, a hybrid motor unit or the like. At least in a state, in which it is arranged on the receiving interface, the energy storage apparatus is preferably arranged between the handle region and the drive unit in such a way that the handle region is arranged on a side of the energy storage apparatus, which side faces away from the tool receptacle, and the drive unit is arranged on a side of the energy storage apparatus, which side faces the tool receptacle. It is also conceivable, however, that, at least in a state, in which it is arranged on the receiving interface, the energy storage apparatus is arranged between the handle region and the drive unit in such a way that the handle region is arranged on a side of the energy storage apparatus, which side faces the tool receptacle, and the drive unit is arranged on a side of the energy storage apparatus, which side faces away from the tool receptacle. By means of the configuration according to the invention, an arrangement of the drive unit and the energy storage apparatus can advantageously be made possible, which arrangement is optimized with regard to an arrangement of a center of mass of the portable machine tool.

Furthermore, it is proposed that, at least in a state, in which it is arranged on the receiving interface, the energy storage apparatus, in particular in an alternative configuration of the portable machine tool and/or the machine tool system, is arranged offset laterally with respect to a drive unit of the portable machine tool, in particular in relation to the movement axis of the tool receptacle. An axis which runs at least substantially perpendicularly with respect to the movement axis of the tool receptacle preferably intersects the drive unit and the energy storage apparatus, in particular in a state of the energy storage apparatus, in which it is arranged on the receiving interface. By means of the configuration according to the invention, a compensation and/or an elimination of lever forces which are caused by way of a weight of the drive unit and by way of a weight of the energy storage apparatus and might lead to an inclination to tilt of the tool receptacle can advantageously be made possible.

In addition, it is proposed that a drive unit of the portable machine tool is arranged offset laterally with respect to a movement axis of the tool receptacle. A drive axis of the drive unit preferably runs at least substantially parallel to the movement axis of the tool receptacle. The drive axis of the drive unit is preferably arranged spaced apart relative to the movement axis of the tool receptacle. By means of the configuration according to the invention, an arrangement of a center of mass in the region of the movement axis of the tool receptacle can advantageously be realized, it being possible for a compensation of forces of the drive unit which act eccentrically to be achieved as a consequence of an arrangement of the energy storage apparatus on the receiving interface of the portable machine tool.

Furthermore, it is proposed that the receiving interface has at least one guide element which has a longitudinal axis which means at least substantially transversely with respect to a movement, axis of the tool receptacle. Here, “substantially transversely” is to be understood to mean, in particular, an orientation of a direction and/or an axis relative to a reference direction and/or a reference axis, the orientation of the direction and/or the axis being at least different from an at least substantially parallel orientation with respect to the reference direction and/or with respect to the reference axis and, in particular, being crooked or perpendicular with respect to the reference direction and/or with respect to the reference axis. The longitudinal axis and the movement axis of the tool receptacle particularly preferably enclose an angle of 90°, in particular in the case of a projection of the longitudinal axis and the movement axis of the tool receptacle into one plane. It is also conceivable in one alternative configuration of the machine tool system, however, that the receiving interface has at least one guide element which has a longitudinal axis which runs at least substantially parallel to a movement axis of the tool receptacle. By means of the configuration according to the invention, a compact arrangement of the energy storage apparatus can advantageously be realized, which compact arrangement makes an advantageous optimization of an arrangement of a center of mass in a close region of a movement axis of the tool receptacle possible.

Furthermore, it is proposed that the longitudinal axis of the guide element runs at least substantially parallel to a tool receiving face of the tool receptacle. An optimum arrangement of a center of mass of the portable machine tool can advantageously be achieved, in particular in order to make a low tendency to tilt of the portable machine tool during machining of a workpiece possible.

In addition, a portable machine tool, in particular a grinding machine, of a machine tool system according to the invention is proposed. By means of the configuration according to the invention, an arrangement of the energy storage apparatus close to the center of the portable machine tool can advantageously be made possible. An optimized arrangement of the center of mass can be achieved with regard to a movement axis of the tool receptacle. Therefore, in particular in the case of a configuration of the portable machine tool as a grinding machine, a tendency to tilt of the portable machine tool during machining of a workpiece can particularly advantageously be kept low. Therefore, precise machining of workpieces can advantageously be made possible. Furthermore, a great use spectrum of the portable machine tool can advantageously be realized as a consequence of a low projecting length of the energy storage apparatus beyond the boundary region, in particular beyond the tool receptacle. An advantageous corner accessibility in as far as possible all orientation positions of the portable machine tool can be achieved.

Here, the machine tool system according to the invention and/or the machine tool according to the invention are/is not to be restricted to the above-described use and embodiment. In particular, the machine tool system according to the invention and/or the machine tool according to the invention can have a number which differs from the number stated herein of individual elements, components and units in order to fulfill a method of operation which is described herein. In addition, in the case of the value ranges which are specified in this disclosure, values which lie within said limits are also to be considered disclosed and capable of being used as desired.

### DRAWING

Further advantages result from the following description of the drawing. Two exemplary embodiments of the invention are shown in the drawing. The drawing, the description and the claims contain numerous features in combination. A person skilled in the art will expediently also consider the features individually and combine them to form appropriate further combinations.

In the drawing:

FIG. 1 shows a machine tool system according to the invention having at least one portable machine tool according to the invention and having at least one energy storage apparatus which is arranged on the portable machine tool, in a diagrammatic illustration,

FIG. 2 shows a plan view of the machine tool system according to the invention, at least one housing element of a housing unit of the machine tool according to the invention being removed, in a diagrammatic illustration,

FIG. 3 shows a side view of the machine tool system according to the invention, at least the housing element of the housing unit of the machine tool according to the invention being removed, in a diagrammatic illustration,

FIG. 4 shows an alternative machine tool system according to the invention having at least one alternative portable machine tool and having at least one energy storage apparatus which is arranged on the portable machine tool, in a diagrammatic illustration, and

FIG. 5 shows a plan view of the alternative machine tool system according to the invention, at least one housing element of a housing unit of the alternative machine tool according to the invention being removed, in diagrammatic illustration.

### DESCRIPTION OF THE EXEMPLARY EMBODIMENTS

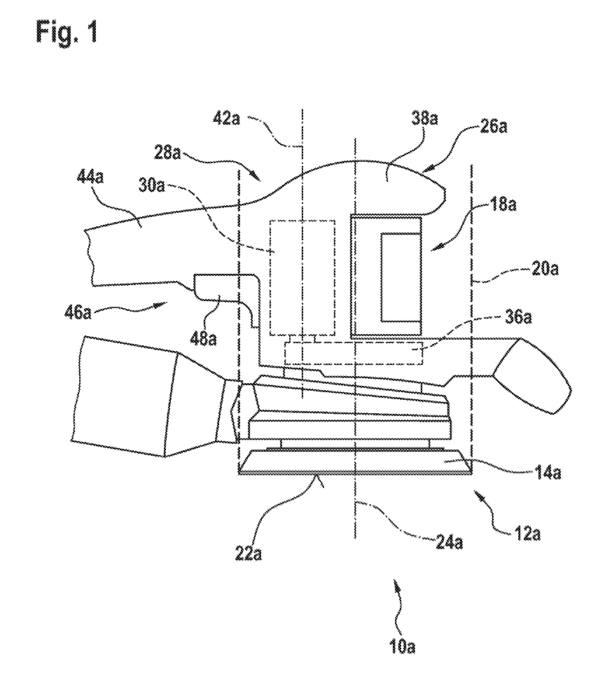

FIGS. 1 to 3 show a machine tool system 10a having at least one portable machine tool 12a which comprises at least one tool receptacle 14a for arranging a machining tool (not shown in greater detail here), and at least one receiving interface 16a. In the exemplary embodiment which is shown in FIGS. 1 to 3, the portable machine tool 12a is configured as a grinding machine, in particular as a rotary sander. It is also conceivable, however, that the portable machine tool 12a has a different configuration which appears appropriate to a person skilled in the art, such as an orbital sander or the like. The portable machine tool 12a has at least one drive unit 30a which is provided to drive the tool receptacle 14a of the portable machine tool 12a. Furthermore, the portable machine tool 12a comprises at least one output unit 36a. The output unit 36a is configured as a wraparound output unit, in particular as a toothed belt output unit. It is also conceivable, however, that the output unit 36a is configured as a gearwheel output unit. The drive unit 30a and the output unit 36a are provided to drive the tool receptacle 14a in a manner which is already known to a person skilled in the art, in particular to drive it rotationally. The tool receptacle 14a can be driven by means of an interaction of the drive unit 30a and the output unit 36a in a manner which is already known to a person skilled in the art so as to rotate eccentrically about a movement axis 24a, in particular a rotational axis, of the tool receptacle 14a, it being possible, in particular, for a center of the tool receptacle 14a to be driven rotationally in an eccentric manner about the movement axis 24a of the tool receptacle 14a in addition to an overall rotation of the tool receptacle 14a about the movement axis 24a of the tool receptacle 14a. It is also conceivable, however, that the portable machine tool 12a is configured so as to be decoupled from the output unit 36a, and that the drive unit 30a is connected directly to the tool receptacle 14a.

The tool receptacle 14a is configured as an abrasive material receptacle, in particular as a grinding disk, on which the machining tool can be fixed by means of a fixing unit (not shown in greater detail here) of the portable machine tool 12a in a manner which is already known to a person skilled in the art. The fixing unit can be configured as a hook and loop closure unit, a clamping unit, a self-adhesive unit or the like. The machining tool is configured as a sanding sheet. It is also conceivable, however, that the machining tool has another configuration which appears appropriate to a person skilled in the art, such as a configuration as a polishing sheet, etc. In a state, in which it is arranged on the tool receptacle 14a, in particular in a state, in which it is fixed on the tool receptacle 14a, the machining tool bears against a tool receiving face 22a of the tool receptacle 14a. The tool receiving face 22a runs at least substantially perpendicularly with respect to the movement axis 24a of the tool receptacle 14a. The tool receiving face 22a is arranged on a side of the tool receptacle 14a, which side faces away from a housing unit 28a of the portable machine tool 12a.

The housing unit 28a is provided to receive at least the drive unit 30a and the output unit 36a. The housing unit 28a has a shell design. It is also conceivable, however, that the housing unit 28a has a cup design or a combination of a shell design and a cup design. The housing unit 28a comprises at least two housing shell elements 38a, 40a which can be fixed on one another. A connecting plane, in which the housing shell elements 38a, 40a bear against one another in a state, in which they are fixed against one another, runs at least substantially perpendicularly with respect to the tool receiving face 22a. In addition, the connecting plane, in which the housing shell elements 38a, 40a bear against one another in a state, in which they are fixed on one another, runs at least substantially parallel to the movement axis 24a of the tool receptacle 14a. The movement axis 24a of the tool receptacle 14a preferably runs in the connecting plane, in which the housing shell elements 38a, 40a bear against one another in a state, in which they are fixed on one another.

Furthermore, the movement axis 24a of the tool receptacle 14a runs at least substantially parallel to a drive axis 42a of the drive unit 30a (FIGS. 1 to 3). It is also conceivable, however, that the movement axis 24a of the tool receptacle 14a runs at least substantially transversely with respect to the drive axis 42a of the drive unit 30a. The drive unit 30a is configured as an electric motor unit. The drive axis 42a of the drive unit 30a is formed by a rotational axis of an armature shaft of the drive unit 30a. In addition, the output unit 36a is provided to mount the tool receptacle 14a such that it can be moved eccentrically relative to the movement axis 24a of the tool receptacle 14a. It is conceivable that the output unit 36a is of switchable configuration, in order, for example, to influence and/or to change a rotational speed of the tool receptacle 14a.

Furthermore, the machine tool system 10a has at least one energy storage apparatus 18a which can be arranged on the receiving interface 16a of the portable machine tool 12a, in particular can be arranged removably on the receiving interface 16a of the portable machine tool 12a. The energy storage apparatus 18a is configured as an accumulator battery apparatus. The energy storage apparatus 18a comprises a multiplicity of rechargeable accumulator battery cells (not shown in greater detail here). The accumulator battery cells of the energy storage apparatus 18a are arranged in a housing of the energy storage apparatus 18a in a manner which is already known to a person skilled in the art, and are connected electrically to one another. The energy storage apparatus 18a is configured as an accumulator battery pack which can be arranged removably on the receiving interface 16a of the portable machine tool 12a. It is also conceivable, however, that the energy storage apparatus 18a has another embodiment which appears appropriate to a person skilled in the art.

At least in a state, in which it is arranged on the receiving interface 16a, the energy storage apparatus 18a is arranged at least for the most part within a boundary region 20a of the tool receptacle 14a. The boundary region 20a is a spatial region which is formed by way of an imaginary parallel displacement of the tool receiving face 22a of the tool receptacle 14a along a direction which runs at least substantially parallel to the movement axis 24a of the tool receptacle 14a, in particular as a result of sweeping over a region starting from the tool receptacle 14a as far as an outer edge of the housing unit 28a, which outer edge is arranged on a side of the housing unit 28a, which side faces away from the tool receptacle 14a. In the exemplary embodiment which is shown in FIGS. 1 to 3, the tool receiving face 22a of the tool receptacle 14a has a circular configuration. The tool receiving face 22a of the tool receptacle 14a is configured as a circular face. It is also conceivable, however, that, in an alternative embodiment of the machine tool system 10a, in particular of the portable machine tool 12a, the tool receiving face 22a of the tool receptacle 14a has a different configuration which appears appropriate to a person skilled in the art, such as a polygonal configuration, in particular a rectangular or a triangular configuration or the like. The boundary region 20a of the tool receptacle 14a is formed as a circular-cylindrical, spatial region, the circumferential face of which is formed, in particular, as a consequence of an imaginary parallel displacement of an annular outer contour of the tool receiving face 22a of the tool receptacle 14a along the direction which runs at least substantially parallel to the movement axis 24a of the tool receptacle 14a.

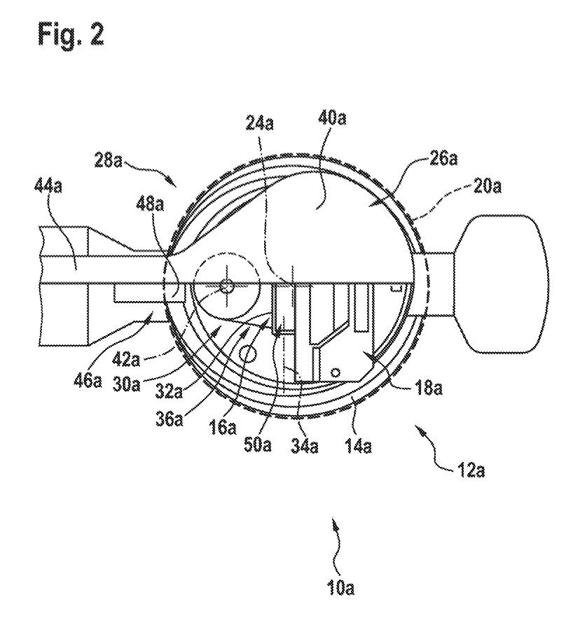

Furthermore, the tool receptacle 14a has an axis which runs through a centroid of the tool receiving face 22a of the tool receptacle 14a, runs at least substantially perpendicularly with respect to the tool receiving face 22a, and intersects the energy storage apparatus 18a (FIG. 2). The axis which runs through a centroid of the tool receiving face 22a of the tool receptacle 14a runs at least substantially parallel to the movement axis 24a of the tool receptacle 14a. The centroid is configured as a circle center of the tool receiving face 22a of the tool receptacle 14a, in particular in the case of a circular configuration of the tool receiving face 22a of the tool receptacle 14a. The axis which runs through a centroid of the tool receiving face 22a of the tool receptacle 14a intersects the energy storage apparatus 18a at least in a contact and/or connecting region 50a of the energy storage apparatus 18a. The contact and/or connecting region 50a is provided for a positively locking and/or non-positive connection and/or for an electric connection of the energy storage apparatus 18a to the receiving interface 16a.

At least in a state, in which it is arranged on the receiving interface 16a, the energy storage apparatus 18a is preferably arranged completely within the boundary region 20a of the tool receptacle 14a. In a state, in which it is arranged on the receiving interface 16a, the energy storage apparatus 18a has a maximum extent, as viewed along a direction which runs at least substantially perpendicularly with respect to the movement axis 24a of the tool receptacle 14a, which maximum extent is smaller than a maximum extent of the tool receiving face 22a of the tool receptacle 14a, as viewed along the direction which runs at least substantially perpendicularly with respect to the movement axis 24a of the tool receptacle 14a. At least in a state, in which it is arranged on the receiving interface 16a, the energy storage apparatus 18a does not extend beyond the tool receptacle 14a, in particular does not extend beyond the tool receiving face 22a, as viewed along the direction which runs at least substantially perpendicularly with respect to the movement axis 24a of the tool receptacle 14a. The energy storage apparatus 18a is arranged at least for the most part, in particular completely, within the circumferential face of the boundary region 20a of the tool receptacle 14a, the circumferential face being formed, in particular, as a consequence of an imaginary parallel displacement of an annular outer contour of the tool receiving face 22a of the tool receptacle 14a along the direction which runs at least substantially parallel to the movement axis 24a of the tool receptacle 14a.

At least in a state, in which it is arranged on the receiving interface 16a, the energy storage apparatus 18a is arranged between a handle region 26a of the housing unit 28a of the portable machine tool 12a and the tool receptacle 14a, as viewed along the movement axis 24a of the tool receptacle 14a. The receiving interface 16a is arranged between the handle region 26a of the housing unit 28a of the portable machine tool 12a and the tool receptacle 14a, as viewed along the movement axis 24a of the tool receptacle 14a. The handle region 26a is arranged on the housing unit 28a on a side of the housing unit 28a, which side faces away from the tool receptacle 14a. The handle region 26a is provided as a rest face for a hand inner face of a hand of an operator of the portable machine tool 12a. A hand inner face of a hand of an operator can preferably be arranged on the handle region 26a in order to produce a pressing force during machining of a workpiece. The handle region 26a is formed by the housing shell elements 38a, 40a. The handle region 26a has a convex configuration. The handle region 26a is of spherical segment-shaped configuration. The handle region 26a is arranged at least for the most part within the boundary region 20a of the tool receptacle 14a.

In addition, the handle region 26a is configured in one piece with a shaft-shaped handle 44a of the housing unit 28a. An operating unit 46a of the portable machine tool 12a is arranged on the shaft-shaped handle 44a. The operating unit 46a is provided at least for activation or deactivation of a power supply and/or for influencing the rotational speed of the drive unit 30a. The operating unit 46a comprises at least one operating element 48a which is arranged on a side of the shaft-shaped handle 44a, which side faces the tool receptacle 14a. The shaft-shaped handle 44a extends beyond the boundary region 20a of the tool receptacle 14a, as viewed along the direction which runs at least substantially perpendicularly with respect to the movement axis 24a of the tool receptacle 14a.

Furthermore, at least in a state, in which it is arranged on the receiving interface 16a, the energy storage apparatus 18a is covered at least partially on at least two sides by the housing unit 28a of the portable machine tool 12a. The receiving interface 16a of the portable machine tool 12a is covered at least partially, in particular completely, on at least two sides by the housing unit 28a of the portable machine tool 12a. At least in a state, in which it is arranged on the receiving interface 16a, the energy storage apparatus 18a. is covered at least partially on at least two sides by the housing unit 28a of the portable machine tool 12a, as viewed along the direction which runs at least substantially perpendicularly with respect to the movement axis 24a of the tool receptacle 14a. The receiving interface 16a of the portable machine tool 12a is covered at least partially, in particular completely, on at least two sides by the housing unit 28a. of the portable machine tool 12a, as viewed along the direction which runs at least substantially perpendicularly with respect to the movement axis 24a of the tool receptacle 1a.

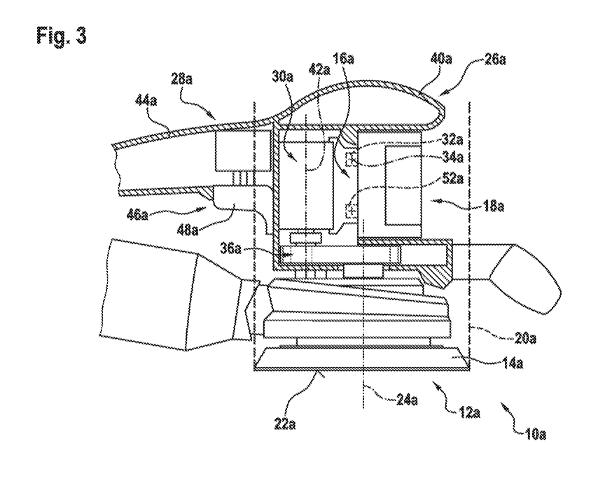

The receiving interface 16a comprises at least one guide element 32a (FIGS. 2 and 3) which has a longitudinal axis 34a which runs at least substantially transversely, in particular at least substantially perpendicularly, with respect to the movement axis 24a of the tool receptacle 14a. The longitudinal axis 34a of the guide element 32a runs at least substantially parallel to the tool receiving face 22a of the tool receptacle 14a. The guide element 32a is configured as a push-in guide groove which interacts for receiving the contact and/or connecting region 50a of the energy storage apparatus 18a which is of corresponding configuration to the guide element 32a, for arranging and/or making electrical contact with the energy storage apparatus 18a in a manner which is already known to a person skilled in the art. Overall, the receiving interface 16a has at least two guide elements 32a, 52a (FIG. 3). It is also conceivable, however, that the receiving interface 16a has a number of guide elements 32a, 52a which differs from two. The guide elements 32a, 52a have an at least substantially analogous configuration. In particular, the guide elements 32a, 52a are arranged and/or configured in a mirror-symmetrical manner.

Furthermore, at least in a state, in which it is arranged on the receiving interface 16a, the energy storage apparatus 18a is arranged offset laterally with respect to the drive unit 30a of the portable machine tool 12a (FIG. 3). The receiving interface 16a is arranged offset laterally with respect to the drive unit 30a of the portable machine tool 12a. At least in a state of the energy storage apparatus 18a, in which it is arranged on the receiving interface 16a, the drive unit 30a is at a spacing from the energy storage apparatus 18a, as viewed along the direction which runs at least substantially perpendicularly with respect to the movement axis 24a of the tool receptacle 14a. The drive unit 30a of the portable machine tool 12a is arranged offset laterally with respect to the movement axis 24a of the tool receptacle 14a.

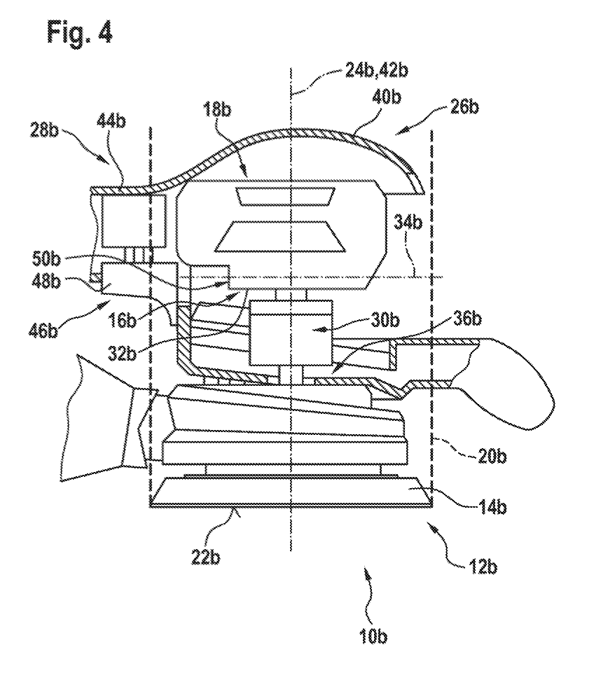

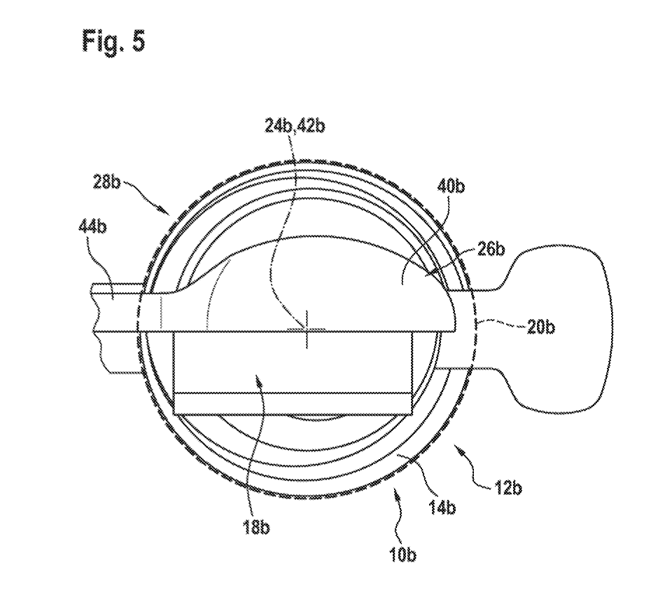

FIGS. 4 and 5 show a further exemplary embodiment of the invention. The following descriptions and the drawing are restricted substantially to the differences between the exemplary embodiments, it being possible fundamentally for reference also to be made to the drawing and/or the description of the other exemplary embodiment of FIGS. 1 to 3 with regard to components of identical designation, in particular in relation to components with identical reference signs. In order to distinguish the exemplary embodiments, the letter a is placed behind the reference signs of the exemplary embodiment in FIGS. 1 to 3. The letter a is replaced by the letter b in the exemplary embodiment of FIGS. 4 and 5.

FIGS. 4 and 5 show an alternative machine tool system 10b having at least one alternative portable machine tool 12b which comprises at least one tool receptacle 14b for arranging a machining tool (not shown in greater detail here), and at least one receiving interface 16b. Furthermore, the machine tool system 10b comprises at least one energy storage apparatus 18b which can be arranged on the receiving interface 16b of the portable machine tool 12b, in particular can be arranged removably on the receiving interface 16b of the portable machine tool 12b. The machine tool system 10b which is shown in FIGS. 4 and 5 has an at least substantially analogous configuration to the machine tool system 10a which is shown in FIGS. 1 to 3. In contrast to the machine tool system 10a which is shown in FIGS. 1 to 3, the machine tool system 10b which is shown in FIGS. 4 and 5 comprises the energy storage apparatus 18b which, at least in a state, in which it is arranged on the receiving interface 16b is arranged at least partially between a handle region 26b of a housing unit 28b of the portable machine tool 12b and a drive unit 30b of the portable machine tool 12b (FIG. 4), as viewed along a movement axis 24b of the tool receptacle 14b. In a state of the energy storage apparatus 18b, in which it is arranged on the receiving interface 16b, the drive unit 30b is arranged in the housing unit 28b on a side of the energy storage apparatus 18b, which side faces the tool receptacle 14b. A drive axis 42b of the drive unit 30b runs coaxially with respect to the movement axis 24b of the tool receptacle 14b. In a state of the energy storage apparatus 18b, in which it is arranged on the receiving interface 16b, the handle region 26b is arranged on the housing unit 28b on a side of the energy storage apparatus 18b, which side faces away from the tool receptacle 14b. With regard to further features and functions of the machine tool system 10b which is shown in FIGS. 4 and 5, reference may be made to the description of the machine tool system 10a which is shown in FIGS. 1 to 3.

1. A machine tool system, comprising:
at least one portable machine tool including:
at least one tool receptacle configured to arrange a machining tool; and
at least one receiving interface;
at least one energy storage apparatus configured to be arranged on the at least one receiving interface of the at least one portable machine tool,
wherein, at least in a state, when the at least one energy storage apparatus is arranged on the at least one receiving interface, the at least one energy storage apparatus is arranged at least for the most part within a boundary region of the at least one tool receptacle.

2. The machine tool system as claimed in claim 1, wherein the at least one tool receptacle defines an axis that runs through a centroid of a tool receiving face of the at least one tool receptacle, runs at least substantially perpendicularly with respect to the tool receiving face, and intersects the at least one energy storage apparatus.

3. The machine tool system as claimed in claim 1, wherein, at least in a state when the at least one energy storage apparatus is arranged on the at least one receiving interface, the at least one energy storage apparatus is arranged between a handle region of a housing unit of the at least one portable machine tool and the at least one tool receptacle, along a movement axis of the at least one tool receptacle.

4. The machine tool system as claimed in claim 1, wherein, at least in a state when the at least one energy storage apparatus is arranged on the at least one receiving interface, the at least one energy storage apparatus is covered at least partially on at least two sides by a housing unit of the at least one portable machine tool.

5. The machine tool system as claimed in claim 1, wherein, at least in a state when the at least one energy storage apparatus is arranged on the at least one receiving interface, the at least one energy storage apparatus is arranged at least partially between a handle region of a housing unit of the at least one portable machine tool and a drive unit of the at least one portable machine tool, along a movement axis of the at least one tool receptacle.

6. The machine tool system as claimed in claim 1, wherein, at least in a state when the at least one energy storage apparatus is arranged on the at least one receiving interface, the at least one energy storage apparatus is arranged offset laterally with respect to a drive unit of the at least one portable machine tool.

7. The machine tool system as claimed in claim 1, wherein a drive unit of the at least one portable machine tool is arranged offset laterally with respect to a movement axis of the at least one tool receptacle.

8. The machine tool system as claimed in claim 1, wherein the at least one receiving interface has includes at least one guide element defining a longitudinal axis that runs at least substantially transversely with respect to a movement axis of the at least one tool receptacle.

9. The machine tool system as claimed in claim 8 wherein the longitudinal axis of the at least one guide element runs at least substantially parallel to a tool receiving face of the at least one tool receptacle.

10. The machine tool system as claimed in claim 1, wherein the portable machine tool is configured as a grinding machine.

11. The machine tool system as claimed in claim 1, wherein the at least one energy storage apparatus is configured to be arranged removably on the at least one receiving interface.
